(19) United States
(12) Patent Application Publication
(10) Pub. No.: US 2025/0276548 A1
(43) Pub. Date: Sep. 4, 2025

(54) REMOVAL TOOL FOR CORE OF AIR VALVE

(71) Applicants: LUNG-KUO HSU, Changhua County (TW); CREATE FOREVER INDUSTRIAL CO., LTD., Changhua County (TW)

(72) Inventor: LUNG-KUO HSU, Changhua County (TW)

(21) Appl. No.: 19/061,301

(22) Filed: Feb. 24, 2025

(30) Foreign Application Priority Data
Mar. 2, 2024 (TW) 113107630
Jul. 5, 2024 (TW) 113207247

(51) Int. Cl. B60C 25/18; B60C 29/06

(52) U.S. Cl. CPC B60C 25/18; B60C 29/06

(57) ABSTRACT

A removal tool is applied to remove a Presta valve, the Presta valve includes a Presta core, the Presta core includes a fixing portion with screw threads, and the fixing portion of the Presta valve has two drive faces not having screw threads. The fixing portion of the Presta valve also has a valve head. The removal tool includes a body. The body includes a Presta detachable head which has a Presta cutout, two Presta actuation planes, and a through orifice. A Presta flexible positioning means is fixed on the Presta cutout of the Presta detachable head of the body and is staggered from the two Presta actuation planes, and the Presta flexible positioning means corresponds to the fixing portion of the Presta core.

### TECHNICAL FIELD

The present invention relates to a removal tool, and more particularly to the removal tool for a core of an air valve.

### BACKGROUND

Conventionally, when filling tire sealant into a tire from an air valve, a core of the air valve is removed. However, the core will be broken since the air valve is damaged after a period of use time, thus causing an unstable air pressure or an air leakage. Therefore, regular inspection and replacement of the core will help ensure that the tire is properly inflated, thus improving a driving safety. When the core inside the air valve of the tire needs to be replaced or routinely maintained, the core must be removed as well.

Referring to FIGS. 14-16, a conventional removal tool 80 for a core of an air valve contains a grip portion 81 and a detachable head 82, wherein the grip portion 81 is configured to be grasped by a user, and the detachable head 82 has an opening 821 defined on an edge thereof, and the opening 821 has a receiving orifice 822 formed on a bottom thereof. In use, the receiving orifice 822 is fitted with the core 92 of the air valve 90, and the opening 821 is engaged with the core 92 of the air 90 so as to rotate the core 92 away from the air valve 90.

The core 92 is detachable easily by using the conventional removal tool 80 but cannot be fixed, so when removing the core 92 from the air valve 90, the core 92 cannot be removed from the air valve 90 by using the removal tool 90 directly, thus manually removing the core 92 from the air valve 90 is required. When removing the core 92 from the air valve 90, the core 92 cannot be fixed by using the removal tool 80 to cause a dropping, thus having a troublesome removal.

The present invention has arisen to mitigate and/or obviate the afore-described disadvantages.

### SUMMARY

The primary aspect of the present invention is to provide a removal tool for a core of an air valve which is simplified to reduce related components, be connected easily, accelerate a connecting process, obtain a stability, lower a fabrication cost, prolong a service life, avoid a removal of the cores, have an easy operation, and enhance a using practicality.

To obtain the above-mentioned aspect, a removal tool for a core of an air valve provided by the present invention contains a body, and the body includes a Presta detachable head formed on an end thereof. The Presta detachable head has a Presta cutout formed on an edge thereof, two Presta actuation planes formed on two sides of the Presta cutout and corresponding to two drive faces of a Presta valve, and the two drive faces have no screw threads. Also, a through orifice is defined on a bottom of the Presta cutout and extends to a top of the Presta cutout.

The removal tool also contains a Presta flexible positioning means fixed on the Presta detachable head of the body and is staggered from the two Presta actuation planes. The through orifice of the body is fitted with the Presta core, the two Presta actuation planes of the Presta cutout are engaged with the two drive faces, and the Presta flexible positioning means abuts against the Presta core.

### BRIEF DESCRIPTION OF THE DRAWINGS

FIG. 1 is a perspective view showing the assembly of a removal tool for a core of an air valve according to a preferred embodiment of the present invention.

FIG. 2 is a perspective view showing the exploded components of the removal tool according to the preferred embodiment of the present invention.

FIG. 3 is a cross-sectional perspective view showing the exploded components of a part of the removal tool according to the preferred embodiment of the present invention.

FIG. 4 is a side plan view showing the assembly of the removal tool according to the preferred embodiment of the present invention.

FIG. 5 is a cross-sectional view taken along the line A-A of FIG. 4.

FIG. 6 is a cross-sectional view taken along the line B-B of FIG. 4.

FIG. 7 is a cross-sectional view taken along the line C-C of FIG. 5.

FIG. 8 is a cross-sectional view showing a Presta valve being removed by using the removal tool according to the preferred embodiment of the present invention.

FIG. 9 is another cross-sectional view showing the Presta valve being removed by using the removal tool according to the preferred embodiment of the present invention.

FIG. 10 is also another cross-sectional view showing the Presta valve being removed by using the removal tool according to the preferred embodiment of the present invention.

FIG. 11 is a cross-sectional view showing a Schrader valve being removed by using the removal tool according to the preferred embodiment of the present invention.

FIG. 12 is another cross-sectional view showing the Schrader valve being removed by using the removal tool according to the preferred embodiment of the present invention.

FIG. 13 is also another cross-sectional view showing the Schrader valve being removed by using the removal tool according to the preferred embodiment of the present invention.

FIG. 14 is a perspective view of a conventional removal tool for a core of an air valve.

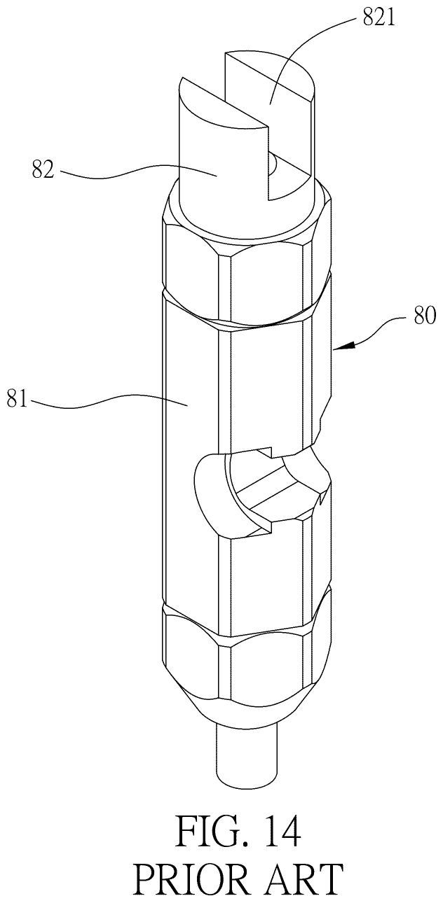

FIG. 15 is a cross-sectional view showing the operation of the conventional removal tool for the core of the air valve.

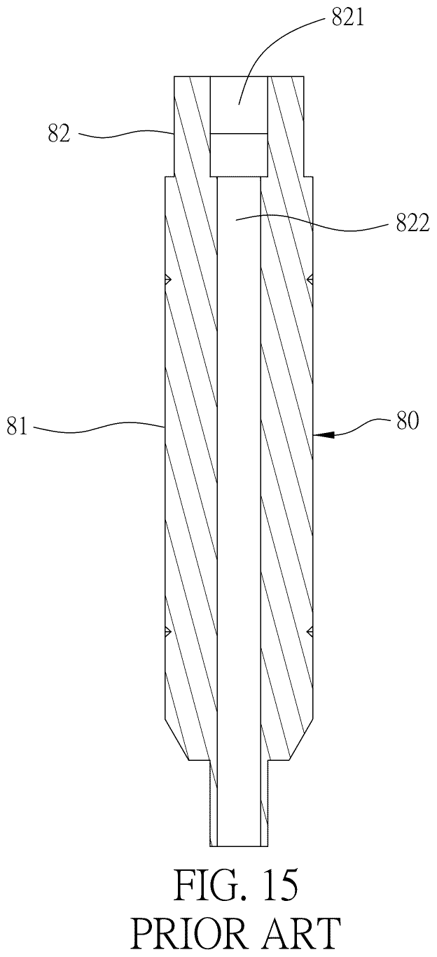

FIG. 16 is another cross-sectional view showing the operation of the conventional removal tool for the core of the air valve.

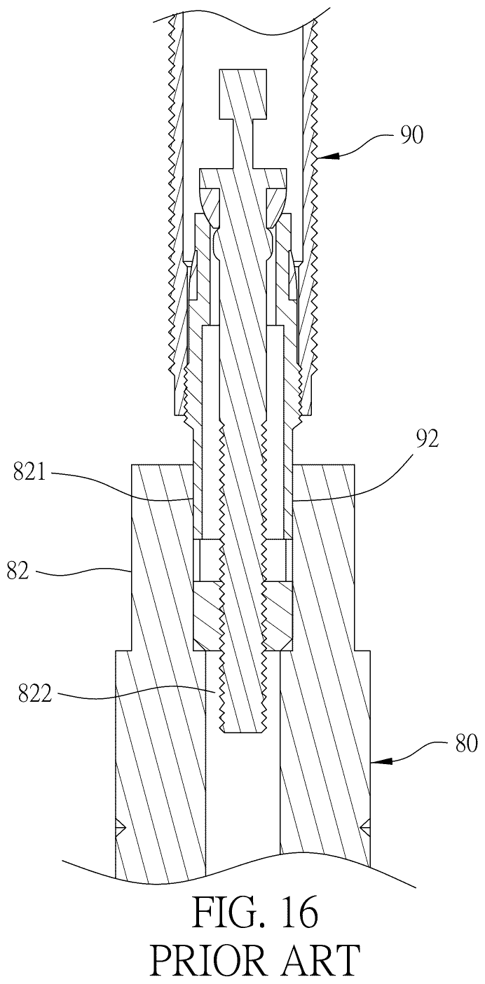

### DETAILED DESCRIPTION

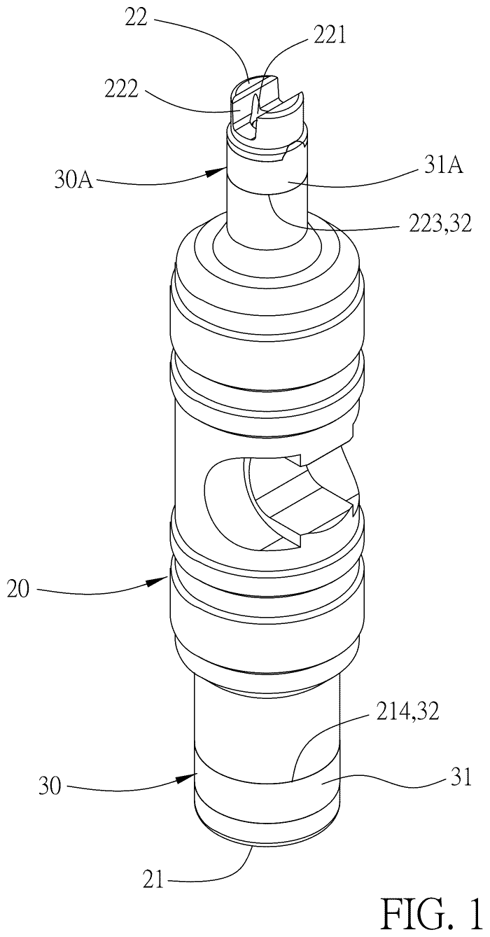

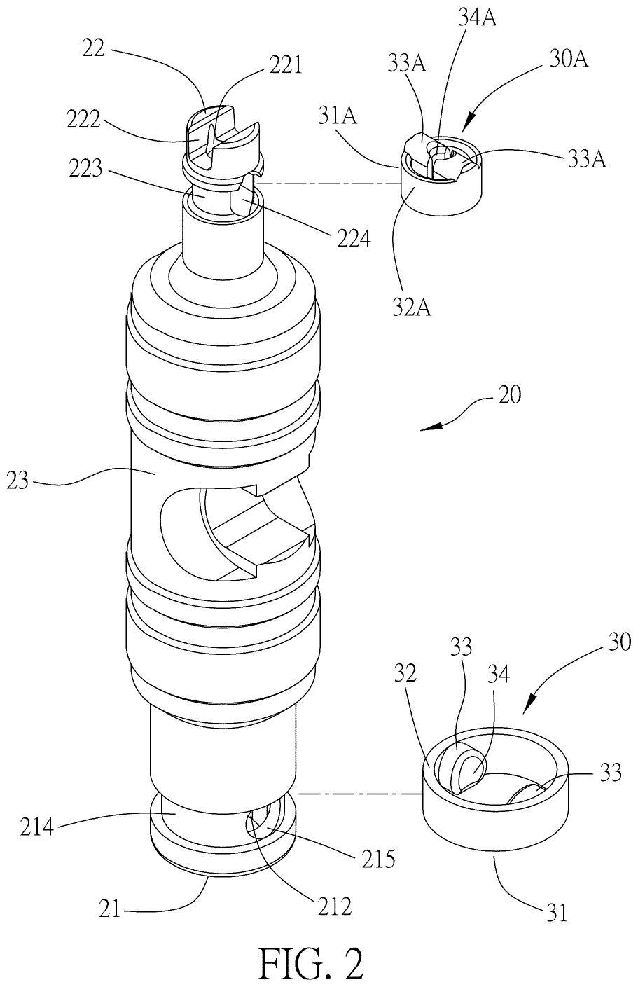

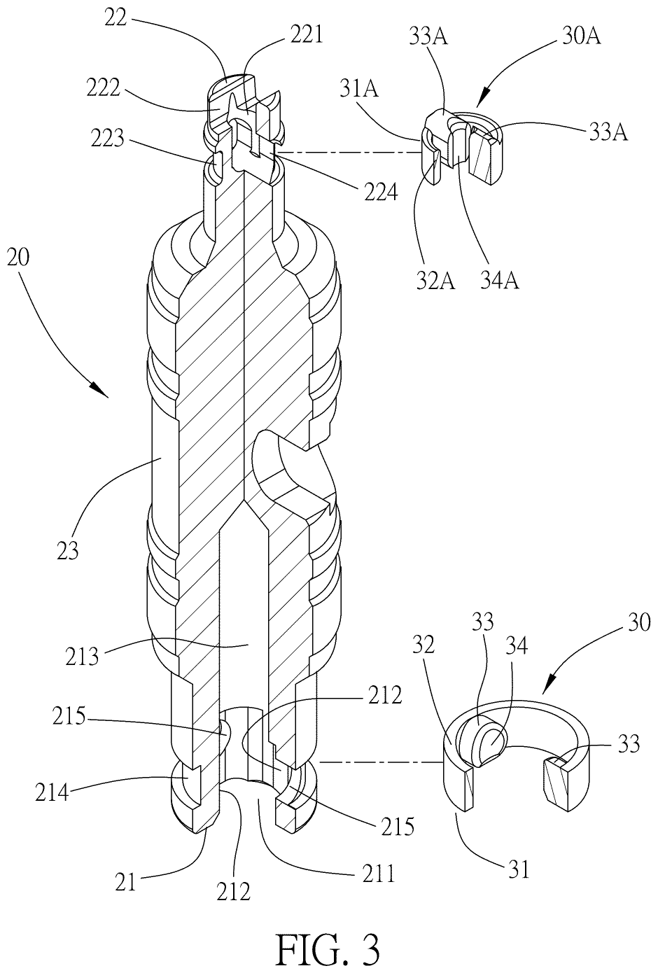

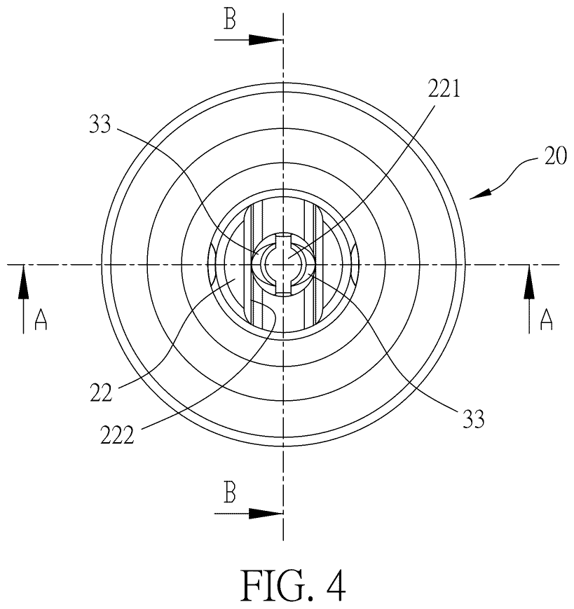

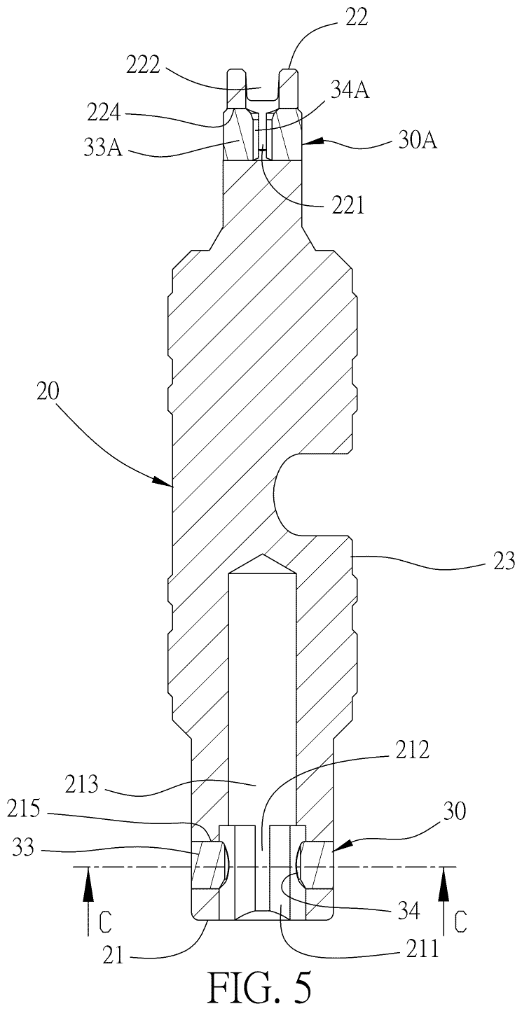

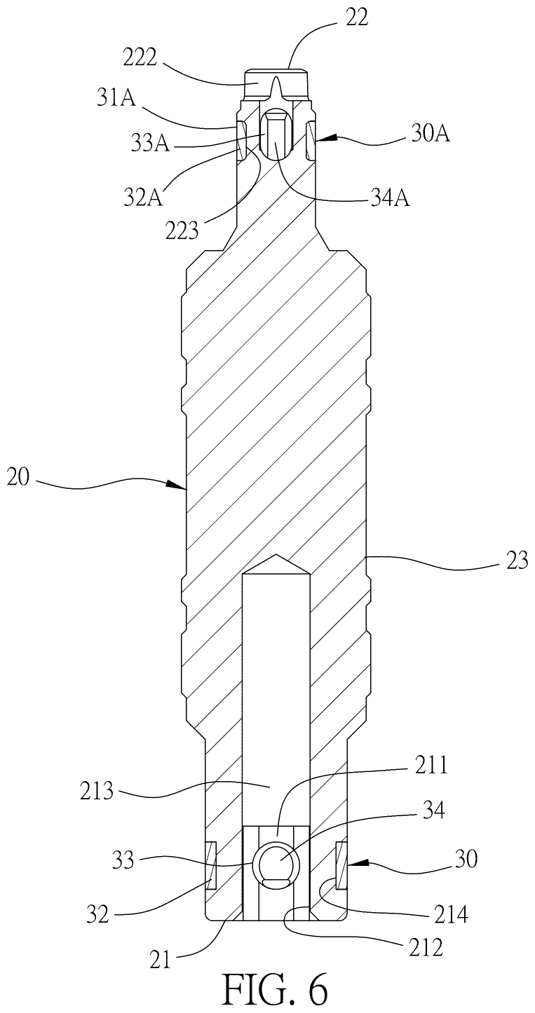

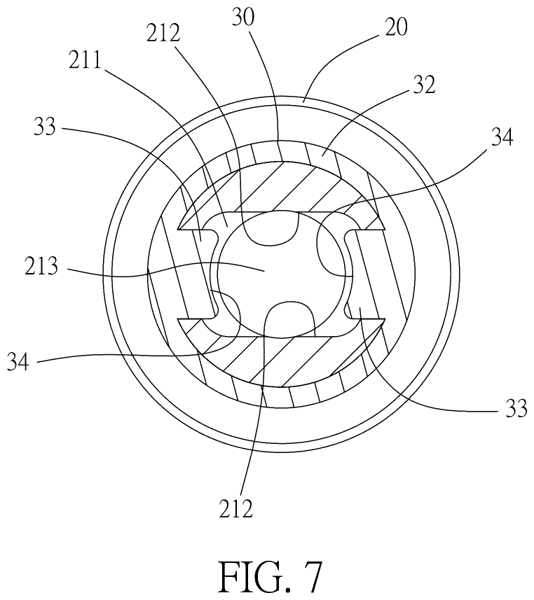

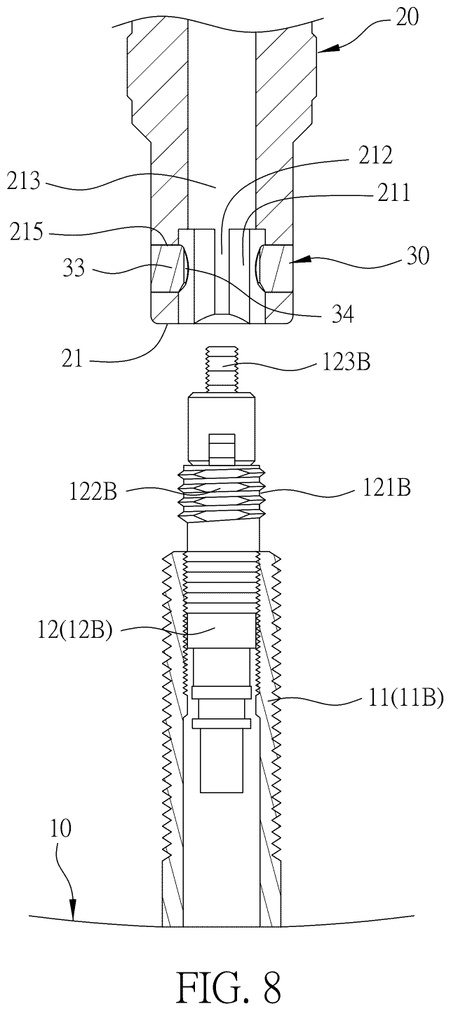

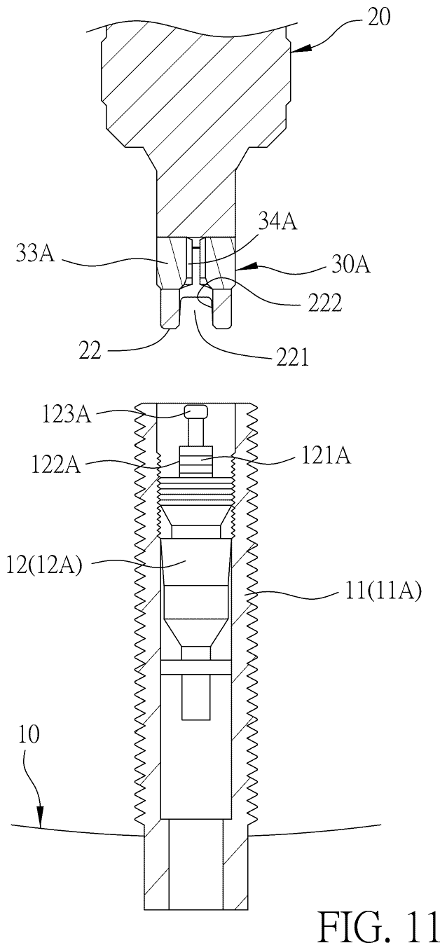

With reference to FIGS. 1-7, a removal tool for a core of an air valve according to a preferred embodiment of the present invention is applied to remove the core 12 of the air valve 11 of a tire 10 (as shown in FIG. 8), the air valve 11 is a Schrader valve 11A (as shown in FIG. 8) or a Presta valve 11B (as illustrated in FIG. 11), wherein the Schrader valve 11A includes a Schrader core 12A accommodated therein, and the Schrader core 12A of the Schrader valve 11A has a fixing portion 121A, the fixing portion 121A of the Schrader valve 11A has two drive faces 122A formed on two sides thereof and has a push needle 123A extending from the fixing portion 121A. The Presta valve 11B includes a Presta core 12B accommodated therein, wherein the Presta core 12B includes a fixing portion 121B with screw threads, and the fixing portion 121B of the Presta valve 11B has two drive faces 122B formed on two sides thereof and not having screw threads, the fixing portion 121B of the Presta valve 11B also has a valve head 123B extending therefrom. The removal tool includes a body 20, a Presta flexible positioning means 30, and a Schrader flexible positioning means 30A.

The body 20 includes a Presta detachable head 21 formed on an end thereof, a Schrader detachable head 22 formed on the other end of the body 20, and a grip portion 23 located away from the Presta detachable head 21 and the Schrader detachable head 22. The Presta detachable head 21 has a Presta cutout 211 formed on an edge thereof, two Presta actuation planes 212 formed on two sides of the Presta cutout 211, a through orifice 213 defined on a bottom of the Presta cutout 211 and extending to a top of the Presta cutout 211, a Presta recess 214 formed on the Presta detachable head 21, and at least one Presta passing orifice 215 defined in the Presta recess 214 and communicated with the Presta cutout 211. The two Presta actuation planes 212 are staggered from the at least one Presta passing orifice 215 in a cross shape. In this embodiment, two Presta passing orifices 215 are provided. The Schrader detachable head 22 has a Schrader cutout 221 formed on an edge thereof, two Schrader actuation planes 222 formed on two sides of the Schrader cutout 221, a Schrader recess 223 formed on the Schrader detachable head 21, and at least one Schrader passing orifice 224 defined in the Schrader recess 223 and communicated with the Schrader cutout 221. In this embodiment, two Schrader passing orifices 224 are provided.

The Presta flexible positioning means 30 is fixed on the Presta detachable head 21 of the body 20, and the Schrader flexible positioning means 30A is fixed on the Schrader detachable head 22. The two Presta actuation planes 212 are staggered from the Presta flexible positioning means 30 in a cross shape. The Presta flexible positioning means 30 corresponds to the fixing portion 121B with the screw threads, wherein the Presta flexible positioning means 30 is a Presta clamp element 31, the Presta clamp element 31 has a flexible Presta connector 32 mounted on an outer wall thereof, and the flexible Presta connector 32 is engaged in the Presta recess 214 and has at least one Presta retainer 33 extending to an inner wall of the flexible Presta connector 32. In this embodiment, two Presta retainers 33 are provided and are connected with the two Presta passing orifices 215, and an extending length of the two Presta retainers 33 are greater than a size of the two Presta passing orifices 215 so that a part of the two Presta retainers 33 extend out of the Presta cutout 211, wherein the part of the two Presta retainers 33 have a Presta arcuate groove 34 extending therefrom, the two Presta retainers 33 of the Presta flexible positioning means 30 of the Presta cutout 211 are staggered from two Presta actuation planes 212 in a cross shape, and the Presta flexible positioning means 30 corresponds to the fixing portion 121B of the Presta valve 11B.

The Schrader flexible positioning means 30A corresponds to the fixing portion 121A with screw threads, wherein the Schrader flexible positioning means 30A is a Schrader clamp element 31A, the Schrader clamp element 31A has a flexible Schrader connector 32A mounted on an outer wall thereof, and the flexible Schrader connector 32A is engaged in the Schrader recess 223 and has at least one Schrader retainer 33A extending to an inner wall of the flexible Schrader connector 33A. In this embodiment, two Schrader retainers 33A are provided and are connected with the two Schrader passing orifices 224, and an extending length of the two Schrader retainers 33A are greater than a size of the two Schrader passing orifices 224 so that a part of the two Schrader retainer 33A extends out of the Schrader cutout 221, wherein the part of the two Schrader retainer 33A has a Schrader arcuate groove 34A extending therefrom, and the Schrader flexible positioning means 30A corresponds to the push needle 123A.

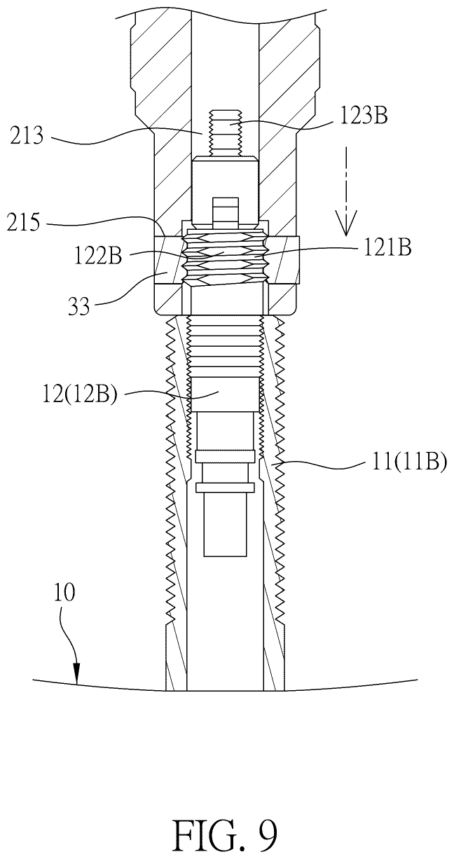

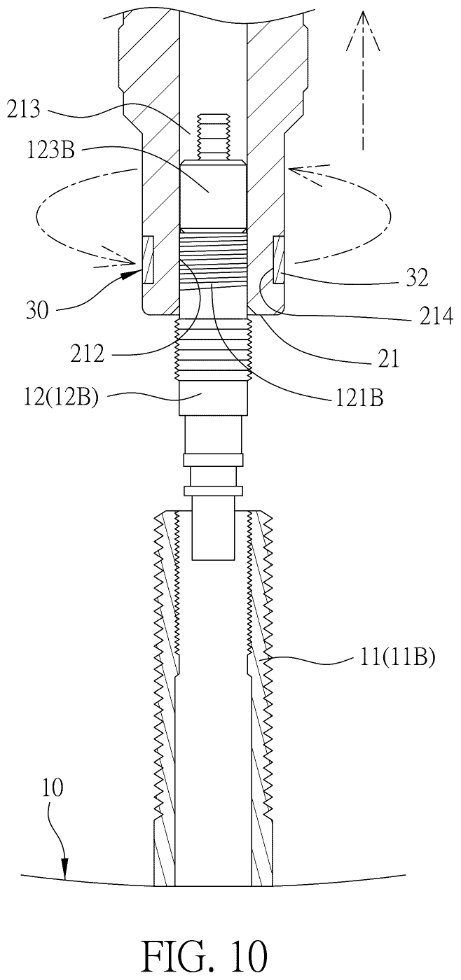

Referring to FIGS. 8-10, when desiring to remove the Presta valve 11B, the Presta detachable head 21 of the body 20 is fitted on the Presta valve 11B so that the Presta core 12B extends into the through orifice 213 of the body 20, the fixing portion 121B of the Presta valve 11B is located in the Presta cutout 211, and the two Presta actuation planes 212 are engaged with the two drive faces 122B of the fixing portion 121B of the Presta valve 11B, wherein the two Presta retainers 33 of the Presta flexible positioning means 30 are flexibly engaged with the fixing portion 121B of the Presta valve 11B, then the grip portion 23 of the body 20 is driven to rotate so that the two Presta actuation planes 212 actuate the Presta core 12B to rotatably remove from the Presta valve 11B. Since the two Presta retainers 33 of the Presta flexible positioning means 30 are flexibly engaged with the fixing portion 121B of the Presta valve 11B, the Presta core 12B is rotatably removed from the Presta valve 11B with the body 20, thus removing the Presta valve 11B securely.

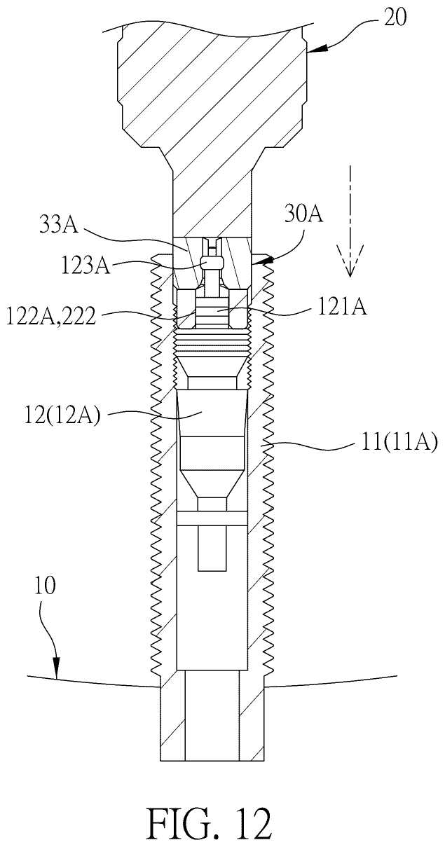

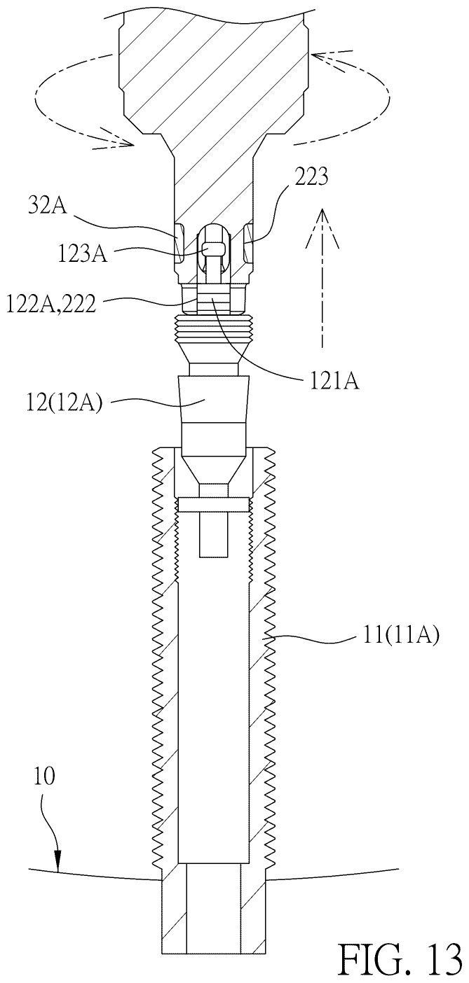

As illustrated in FIGS. 11-13, when desiring to remove the Schrader valve 11A, the Schrader detachable head 22 of the body 20 is fitted on the Schrader valve 11A so that the two Schrader actuation planes 122A are engaged with the Schrader cutout 221, wherein the two Schrader retainers 33A of the Schrader flexible positioning means 30A are flexibly engaged with the push needle 123A, then the body 20 is rotated to actuate the Schrader core 12A to remove from the Schrader valve 11A, and the Schrader valve 11A is detachable.

Thereby, the removal tool of the present invention has the following advantages:

The removal tool is simplified to reduce related components, be connected easily, accelerate a connecting process, obtain a stability, lower a fabrication cost, prolong a service life, avoid a removal of the cores 12, have an easy operation, and enhance a using practicality.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. A removal tool being applied to remove a Presta valve, the Presta valve including a Presta core accommodated in the Presta valve, wherein the Presta core includes a fixing portion with screw threads, and the fixing portion of the Presta valve has two drive faces formed on two sides thereof and not having screw threads, the fixing portion of the Presta valve also has a valve head extending therefrom;
wherein the removal tool includes:
a body which includes a Presta detachable head formed on an end of the body, wherein the Presta detachable head has a Presta cutout formed on an edge thereof, two Presta actuation planes formed on two sides of the Presta cutout and corresponding to the two drive faces of the Presta valve, and a through orifice defined on a bottom of the Presta cutout and extending to a top of the Presta cutout; and
wherein a Presta flexible positioning means is fixed on the Presta cutout of the Presta detachable head of the body and is staggered from the two Presta actuation planes, and the Presta flexible positioning means corresponds to the fixing portion of the Presta core;
wherein the Presta core is fitted into the through orifice of the body, the two Presta actuation planes are engaged with the two drive faces of the Presta cutout, and the Presta flexible positioning means abuts against the fixing portion of the Presta valve so that the removal tool actuates the Presta core to rotate away from the Presta valve, thus removing the Presta core.

2. The removal tool as claimed in claim 1, wherein the Presta flexible positioning means is fixed on the Presta cutout and is staggered from the two Presta actuation planes in a cross shape.

3. The removal tool as claimed in claim 2, wherein the Presta detachable head has a Presta recess formed thereon, and at least one Presta passing orifice defined in the Presta recess and communicated with the Presta cutout, wherein the two Presta actuation planes are staggered from the at least one Presta passing orifice in a cross shape;
wherein the Presta flexible positioning means is a Presta clamp element, and the Presta clamp element has a flexible Presta connector engaged in the Presta recess, wherein the flexible Presta connector has at least one Presta retainer extending to an inner wall thereof, and the at least one Presta retainer is connected with the at least one Presta passing orifice, wherein an extending length of the at least one Presta retainer is greater than a size of the at least one Presta passing orifice so that the at least one Presta retainer extends out of the Presta cutout.

4. The removal tool as claimed in claim 3, wherein the part of the at least one Presta retainer has a Presta arcuate groove extending therefrom.

5. The removal tool as claimed in claim 1, wherein the body includes a Schrader detachable head formed on the other end thereof and configured to remove a Schrader core of a Schrader valve, the Schrader detachable head includes a Schrader recess formed thereon, at least one Schrader passing orifice defined in the Schrader recess and communicated with the Schrader cutout, and a Schrader flexible positioning means is fixed on the Schrader detachable head, wherein the Schrader flexible positioning means corresponds to the fixing portion of Schrader core and the fixing portion of the Schrader core has screw threads, wherein the Schrader flexible positioning means is a Schrader clamp element, the Schrader clamp element has a flexible Schrader connector mounted on an outer wall thereof, and the flexible Schrader connector is engaged in the Schrader recess and has at least one Schrader retainer extending to an inner wall of the flexible Schrader connector; wherein the at least one Schrader retainer is connected with the at least one Schrader passing orifice, and an extending length of the at least one Schrader retainer is greater than a size of the at least one Schrader passing orifice so that the at least one Schrader retainer extends out of the Schrader cutout, and the at least one Schrader retainer corresponds to the push needle.

6. The removal tool as claimed in claim 5, wherein the part of the at least one Schrader retainer has a Schrader arcuate groove extending therefrom.
